(19) United States
(12) Patent Application Publication
(10) Pub. No.: US 2025/0280943 A1
(43) Pub. Date: Sep. 11, 2025

(54) MAGNETIC ACCESSORY HOLDER

(71) Applicant: Karris Davis, Sandy, UT (US)

(72) Inventor: Karris Davis, Sandy, UT (US)

(21) Appl. No.: 18/600,207

(22) Filed: Mar. 8, 2024

(51) Int. Cl. A45F 5/02; A63B 57/20; F16M 13/02

(52) U.S. Cl. CPC A45F 5/02; A63B 57/203; F16M 13/022; A45F 5/1508; A45F 5/1575; A63B 2209/08

(57) ABSTRACT

A magnetic accessory holder can include a backing plate and a retaining bracket attached magnetically to each other. The backing plate can include an elongated body with a first set of magnets embedded in the body. The retaining bracket can include an outer surface and an inner surface, each of which extends between the top and bottom surfaces of the retaining bracket. The inner surface can include elongated channels each of which forms a receptacle extending from the top surface to the bottom surface of the retaining bracket. The retaining bracket can also include a second of magnets, where the magnets of the first set and of the second set are positioned to align with each other to fasten the retaining bracket to the backing plate by magnetic attraction, and where each receptacle is configured to receive a protruding portion of an electronics accessory.

### TECHNICAL FIELD

The implementations of the disclosure relate generally to accessory retaining devices. More specifically, the embodiments disclosed herein relate to magnetic accessory holders that can be attached to items of clothing.

### BACKGROUND

In today's fast-paced world, wireless technology and small accessories, particularly earbuds and small sport equipment, play a crucial role in daily communication and entertainment. However, users frequently face the inconvenience and financial burden of losing their small accessories (e.g., wireless earbuds, writing utensils, golf tees, etc.) due to the lack of a secure and accessible storage solution when not in use. Recognizing the need for a more efficient way to keep small accessories and electronics readily available without resorting to carrying bulky cases or risking loss by placing them loosely in pockets, the embodiments disclosed herein introduce a novel approach to integrating accessory storage directly with clothing and other apparel, such as hats, offering an innovative solution to the common problem of accessory misplacement. Existing solutions are inadequate to address the need for a combination of ease of access, comfort, and secure storage. The embodiments of the present disclosure not only provide users with a simple, stylish way to store their accessories directly on their person but also significantly reduces the likelihood of loss or damage, ultimately saving users time and money. By reimagining how accessories can be carried and accessed, the various embodiments further described in more detail below, set out a new approach for the integration of personal technology with everyday apparel and accessories, marking a significant advancement in the field of accessory holders. By implementing the various embodiments disclosed herein, users can enjoy the convenience of having their accessories within easy reach at all times, ready to be used or stored in a moment's notice, without the hassle of traditional carrying cases or the risk of misplacement, thus revolutionizing the user experience in interacting with their accessories such as wireless audio devices.

### SUMMARY OF THE DISCLOSURE

Embodiments of the present disclosure describe apparatuses for holding accessories and attaching them to layers of materials such as items of clothing.

Embodiments of the present disclosure can include a magnetic accessory holder that has a backing plate including an elongated body where a first set of magnets is at least partially embedded in the body of the backing plate. In some embodiments, each magnet of the first set of magnets can be partially embedded in the elongated body of the backing plate and can also be partially protruding from the body of the backing plate. The magnetic accessory holder can also have a retaining bracket that has an outer surface and an inner surface where each of the outer surface and the inner surface extend between a top surface and a bottom surface of the retaining bracket. The inner surface can define one or more elongated channels where each elongated channel forms a receptacle extending from the top surface to the bottom surface of the retaining bracket. Each receptacle can be separated from another receptacle by a portion of the retaining bracket.

In some embodiments, the retaining bracket of the magnetic accessory holder can include a second set of magnets, where each magnet in the second set of magnets is positioned to align with at least one magnet of the first set of magnets that is at least partially embedded in the body of the backing plate. In some embodiments, each set of magnets can include three or more magnets. The aligned sets of magnets can fasten the retaining bracket to the backing plate by magnetic attraction and each receptacle can be configured to receive a protruding portion of an electronics accessory. In some embodiments each receptacle can be shaped as a partially open cylindrical tube.

In some of these embodiments, the retaining bracket can also include a lip extending perpendicularly relative to a length between the top surface and the bottom surface and at least one magnet of the second set of magnets can be embedded in the lip. In the embodiments, the inner surface of the retaining bracket can be a textured surface.

Other embodiments of the present disclosure can include a magnetic accessory holder that has a substantially flat backing plate having an elongated body and a first set of magnets including at least one magnet that is at least partially embedded in the body of the substantially flat backing plate. The embodiments of the magnetic accessory holder can also include a retaining bracket configured to magnetically attach to the substantially flat backing plate through a layer of intervening material.

The retaining bracket can include a top surface, a bottom surface, an outer surface extending between the top surface and the bottom surface, where the outer surface has multiple curved areas. The retaining bracket can also include an inner surface extending between the top surface and the bottom surface where a portion of the inner surface defines a one or more concave walls and where each concave wall defines an elongated receptacle and extends between the top surface and the bottom surface. Each receptacle can be shaped as a prismoidal partially open tube. In some embodiments, each magnet of the first set of magnets can be fully embedded in the backing plate such that an exposed surface of the magnet is flush with a surface of the backing plate.

The retaining bracket can also include multiple tabs where each tab respectively extends from an end of a corresponding curved area of the outer surface and where each tab includes magnetic material. Each tab can be respectively positioned to align with a corresponding magnet of the first set of magnets on the substantially flat backing plate to fasten the retaining bracket to the backing plate by magnetic attraction, and each receptacle can be configured to receive a protruding portion of a sport accessory.

In some of these embodiments, the magnetic accessory holder also includes a second set of magnets, where a magnet of the second set of magnets is respectively attached to a corresponding tab of the retaining bracket and protrudes perpendicularly relative to the inner surface of the retaining bracket. In some embodiments, each tab can be a magnet. The retaining bracket can also include a conformal layer attached along the inner surface of the retaining bracket and the conformal layer can include a textured surface. In these embodiments the sport accessory that each receptacle is configured to receive can be an ear bud or a golf tee.

Still other embodiments of the present disclosure can include an accessory holder that has a backing plate, a first set of magnets affixed to the backing plate, and a retaining bracket with a body having multiple flat surfaces and multiple curved surfaces disposed along the body. The surfaces can be disposed along the body such that a curved surface alternates with a flat surface along the length of the body of the retaining bracket, and where each curved surface defines a partially open tubular channel forming a receptacle configured to receive a protruding portion of an accessory. In some embodiments, the accessory holder can include a second set of magnets affixed to the retaining bracket, where each magnet of the second set of magnets is respectively aligned with a corresponding magnet of the first set of magnets to fasten the retaining bracket to the backing plate by magnetic attraction through a layer of intervening material. In some embodiments, at least two flat surfaces of the body of the retaining bracket each respectively extend along a portion of a lip extending away from an exterior curved surface of the body of the retaining bracket away from a longitudinal axis of the partially open tubular channel formed by an interior curved surface of the retaining bracket. In these or other embodiments, each curved surface can be a textured surface that is textured with grooves or protrusions. In some of these embodiments, the accessory can be a wireless earbud, a golf tee, a screwdriver, pliers, a writing utensil, a dining utensil, or a similar object having an elongated protrusion.

These and other embodiments are described in more detail in the following detailed description.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only. One of ordinary skill in the art would appreciate that these are merely example embodiments, and that additional and alternative embodiments may exist and still be within the spirit of the disclosure as described herein.

The disclosure will provide details in the following description of preferred embodiments with reference to the following figures wherein:

FIG. 1A is a front perspective view of a magnetic accessory holder in accordance with some embodiments of the present disclosure;

FIG. 1B is a front perspective view of a magnetic accessory holder in accordance with some embodiments of the present disclosure;

FIG. 2A is a rear perspective view of a magnetic accessory holder in accordance with some embodiments of the present disclosure;

FIG. 2B is a rear perspective view of a magnetic accessory holder in accordance with some embodiments of the present disclosure;

FIG. 3A is a front view of a magnetic accessory holder in accordance with some embodiments of the present disclosure;

FIG. 3B is a front view of a magnetic accessory holder in accordance with some embodiments of the present disclosure;

FIG. 4A is a rear view of a magnetic accessory holder in accordance with some embodiments of the present disclosure;

FIG. 4B is a rear view of a magnetic accessory holder in accordance with some embodiments of the present disclosure;

FIG. 5A is a right side view of a magnetic accessory holder in accordance with some embodiments of the present disclosure;

FIG. 5B is a right side view of a magnetic accessory holder in accordance with some embodiments of the present disclosure;

FIG. 6A is a left side view of a magnetic accessory holder in accordance with some embodiments of the present disclosure;

FIG. 6B is a left side view of a magnetic accessory holder in accordance with some embodiments of the present disclosure;

FIG. 7A is a top view of a magnetic accessory holder in accordance with some embodiments of the present disclosure;

FIG. 7B is a bottom view of a magnetic accessory holder in accordance with some embodiments of the present disclosure;

FIG. 8A is a top view of a magnetic accessory holder in accordance with some embodiments of the present disclosure;

FIG. 8B is a bottom view of a magnetic accessory holder in accordance with some embodiments of the present disclosure;

FIG. 9A is a rear perspective view of a conformal layer of a retaining bracket in accordance with some embodiments of the present disclosure;

FIG. 9B is a rear perspective view of a conformal layer of a retaining bracket in accordance with some embodiments of the present disclosure;

FIG. 10A is a front perspective view depicting a conformal layer of a retaining bracket attached to a back plate in accordance with some embodiments of the present disclosure;

FIG. 10B is a front perspective view depicting a conformal layer of a retaining bracket attached to a back plate in accordance with some embodiments of the present disclosure;

FIG. 11A is a front perspective view of a magnetic accessory holder in accordance with some embodiments of the present disclosure;

FIG. 11B is a front perspective view of a magnetic accessory holder in accordance with some embodiments of the present disclosure;

FIG. 12A is a front perspective view of a backing plate with empty apertures in accordance with some embodiments of the present disclosure;

FIG. 12B is a front perspective view of a backing plate with empty apertures in accordance with some embodiments of the present disclosure;

FIG. 13A is a front perspective view of a backing plate with embedded magnets in accordance with some embodiments of the present disclosure;

FIG. 13B is a front perspective view of a backing plate with embedded magnets in accordance with some embodiments of the present disclosure;

FIG. 14 is front perspective view of a backing plate with a set of embedded magnets connected to a corresponding set of magnets in accordance with some embodiments of the present disclosure;

FIG. 15 is a rear perspective view of a retaining bracket in accordance with some embodiments of the present disclosure;

FIG. 16A is a rear perspective view of a backing plate being attached to a retaining bracket through an intervening layer of material (e.g., fabric, clothing) in accordance with some embodiments of the present disclosure;

FIG. 16B is a rear perspective view of a backing plate being attached to a retaining bracket through an intervening layer of material (e.g., fabric, clothing) in accordance with some embodiments of the present disclosure;

FIG. 17 is a front perspective view of a magnetic accessory holder holding a pair of earbuds attached to a hat in accordance with some embodiments of the present disclosure; and

FIG. 18 is a front view of a magnetic accessory holder holding a pair of golf tees attached to a chest portion of a shirt and a magnetic accessory holder holding a pair of earbuds attached to a sleeve portion of the shirt in accordance with some embodiments of the present disclosure.

### DETAILED DESCRIPTION

In the Summary above and in this Detailed Description, and the claims below, and in the accompanying drawings, reference is made to particular features of various embodiments of the invention disclosed herein. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

Reference in this specification to “one embodiment” or “an embodiment” of the present invention, as well as other variations thereof, means that a particular feature, structure, characteristic, and so forth described in connection with the embodiment is included in at least one embodiment of the invention. Thus, the appearances of the phrase “in one embodiment” or “in an embodiment”, as well any other variations, appearing in various places throughout the specification are not necessarily all referring to the same embodiment.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present description, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present description does not explicitly recite each and every permutation that may be obtained by choosing from the set of optional features. However, the present description is to be interpreted as explicitly disclosing all such permutations. For example, a device described as having three optional features may be embodied in seven different ways, namely with just one of the three possible features, with any two of the three possible features or with all three of the three possible features.

In the present description, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

It will also be understood that when an element is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected”, “mounted”, “affixed”, “attached”, or “coupled” to another element, it can be directly connected, mounted, affixed, attached, or coupled to the other element or intervening elements can be present. In contrast, when an element is referred to as being “directly connected”, “directly mounted”, or “directly coupled” to another element, there are no intervening elements present. It should be understood that the terms “connected”, “mounted”, “affixed”, “attached”, or “coupled” are used interchangeably herein.

Aspects and implementations of the instant disclosure address the above noted and other deficiencies of the existing technology by enabling the secure retention of various accessories to close and fabric as well as other similar articles in a convenient and easily accessible manner. For example, wireless headphones can be securely inserted into the receptacles of the accessory holder and easily accessed for use or storage in the various embodiments of the present disclosure. In another example implementation, golf tees can be securely inserted into the receptacles of the accessory holder and easily accessed for use or storage in the various embodiments of the present disclosure. Similarly, other items, utensils, and accessories conforming to the elongated receptacle shape (e.g., pens, pencils, eyeglasses, etc.) can likewise be securely stored or held by the receptacles of the accessory in the various embodiments described herein.

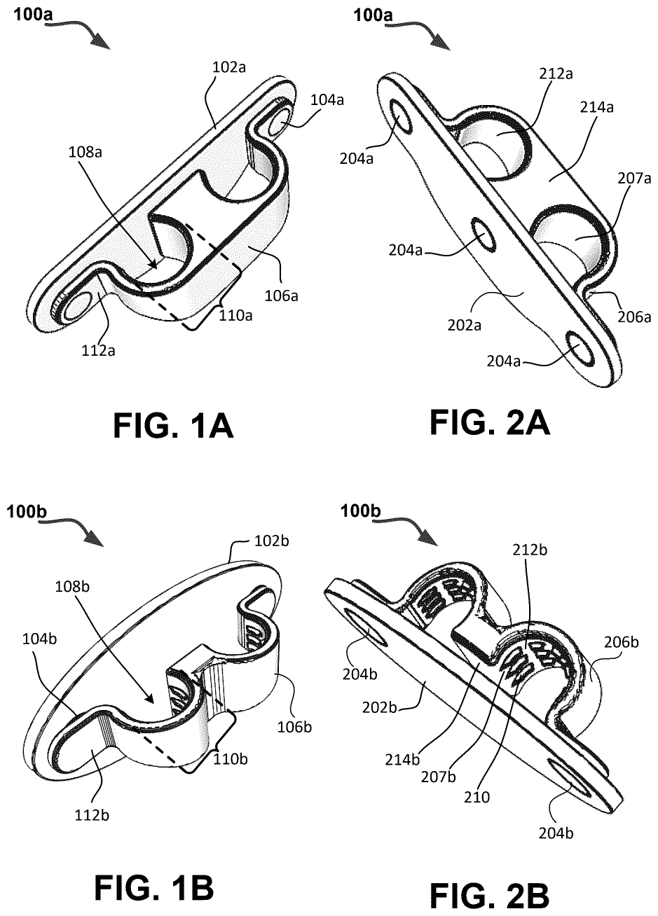

Initially, FIG. 1A offers a front perspective view of a magnetic accessory holder 100a, while FIG. 2A shows a rear perspective view of a magnetic accessory holder 100a, respectively in accordance with some embodiments of the present disclosure. Similarly, FIGS. 2A-2B respectively illustrate a front perspective view of a magnetic accessory holder 100b and a rear perspective view of a magnetic accessory holder 100b, in accordance with various embodiments. These embodiments of the present disclosure can include a magnetic accessory holder 100a, 100b that has a backing plate 102a, 102b including an elongated backing plate body 202a, 202b. The backing plate body 202a, 202b can have a first set of magnets, where each magnet 204a, 204b is at least partially embedded in the body 202a, 202b of the backing plate 102a, 102b. In some embodiments, each magnet 204a, 204b of the first set of magnets can be partially embedded in the elongated body 202a, 202b of the backing plate and can also be partially protruding from the backing plate body 202a, 202b.

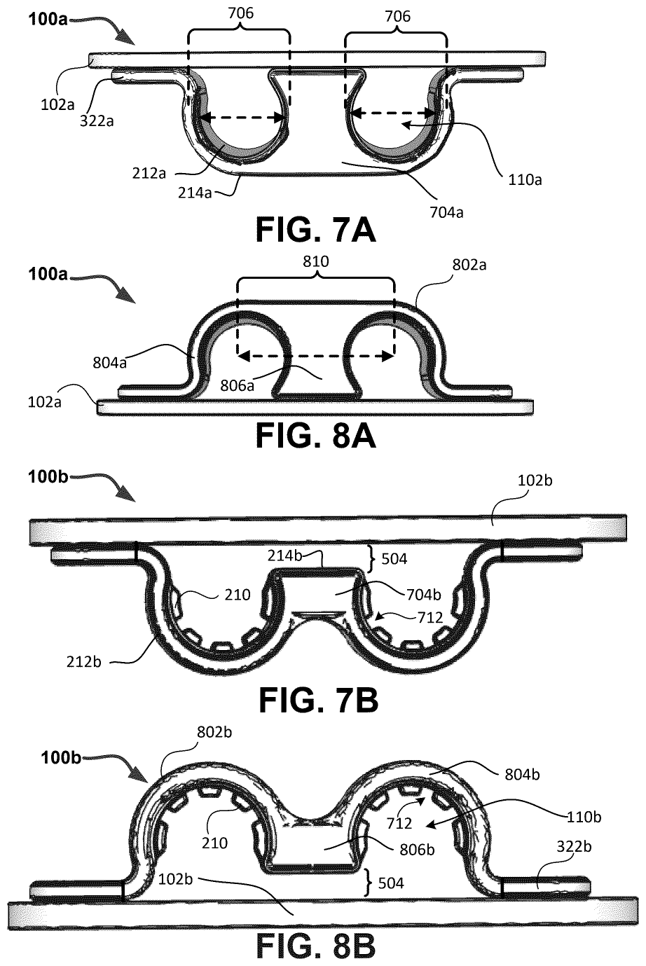

The magnetic accessory holder 100a, 100b can also have a retaining bracket 106a, 106b that has an outer surface 206a, 206b and an inner surface 207a, 207b where each of the outer surface 206a, 206b and the inner surface 207a, 207b extend between a top surface and a bottom surface of the retaining bracket. The inner surface 207a, 207b can define one or more elongated channels 108a, 108b where each elongated channel 108a, 108b forms a receptacle 110a, 110b extending from the top surface to the bottom surface of the retaining bracket 106a, 106b. The top and bottom surfaces are described in more detail below with reference to FIGS. 7A-8B. Each receptacle 110a, 110b can be separated from another receptacle by a portion of the retaining bracket as further described with reference to FIGS. 8A-8B.

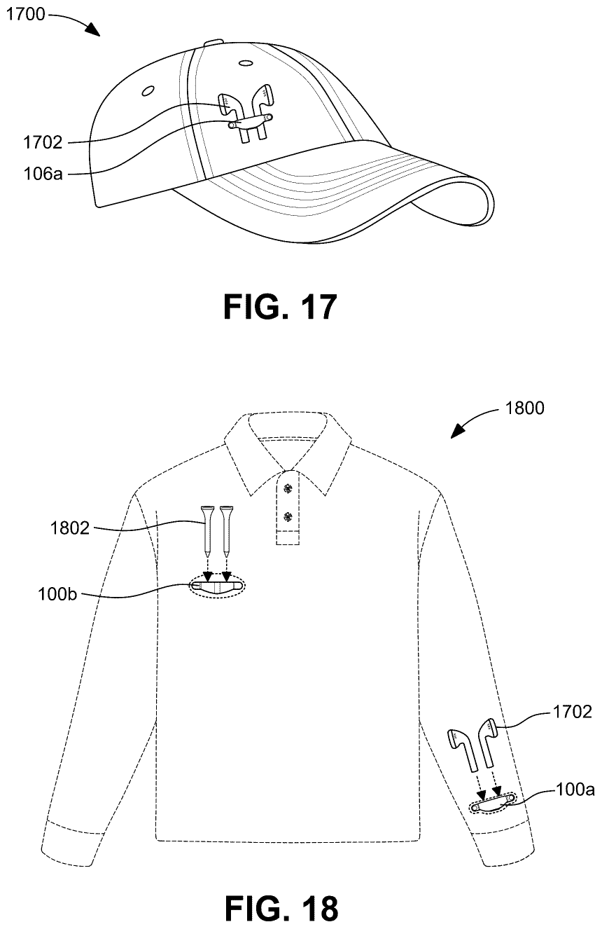

In some embodiments, the retaining bracket 106a, 106b of the magnetic accessory holder 100a, 100b can include a second set of magnets, where each magnet 104a, 104b in the second set of magnets is positioned to align with at least one magnet 204a, 204b of the first set of magnets, where each magnet 204a, 204b is at least partially embedded in the body 202a, 202b of the backing plate 102a, 102b. In some embodiments, each set of magnets can include one or more (e.g., two, three, four, etc.) magnets 204a, 204b. While depicted as circular in cross-section and cylindrical in shape, it is contemplated that the magnets 104a, 104b, 204a, 204b can be of any suitable shape (e.g., prismoidal or substantially flat) and cross-section (e.g., square, rectangular, elliptical, oval, triangular, hexagonal, octagonal, or in the shape of any other regular or irregular polygon). The aligned sets of magnets can fasten the retaining bracket 106a, 106b to the backing plate 102a, 102b by magnetic attraction. In these and other embodiments, each receptacle 110a, 110b can be configured to receive a protruding portion of an electronics accessory as shown in more detail in FIG. 17. In some embodiments, each receptacle 110a, 110b can be shaped as a partially open cylindrical tube.

In some of these embodiments, the retaining bracket 106a, 106b can also include a lip 112a, 112b extending perpendicularly relative to a length between the top surface and the bottom surface of the retaining bracket 106a, 106b. Additionally, in some embodiments, at least one magnet 104a of the second set of magnets can be embedded in the lip 112a of the retaining bracket 106a. In these or other embodiments, the inner surface 207b of the retaining bracket 106b can be a textured surface.

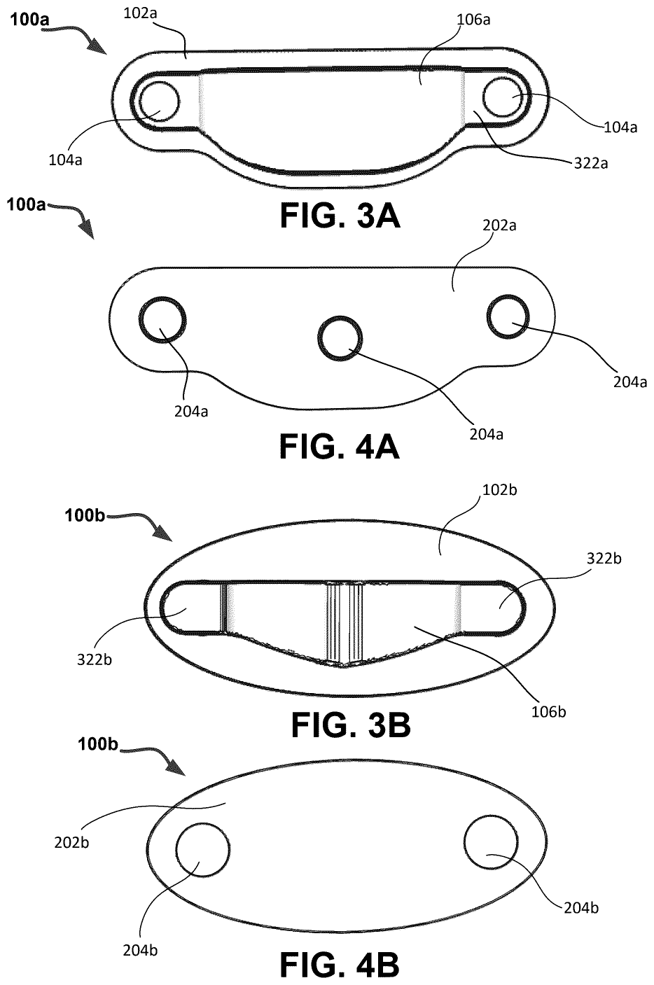

With continued reference to FIGS. 1A-2B and turning to FIGS. 3A-4B which each respectively illustrate either a front view or a rear view of a magnetic accessory holder 100a, 100b in accordance with some embodiments. These several embodiments can include a magnetic accessory holder 100a, 100b that has a substantially flat backing plate 102a, 102b having an elongated body 202a, 202b and a first set of magnets including at least one magnet 204a, 204b that is at least partially embedded in the body 202a, 202b of the substantially flat backing plate 102a, 102b.

The embodiments of the magnetic accessory holder 100a, 100b can also include a retaining bracket 106a, 106b configured to magnetically attach to the substantially flat backing plate 102a, 102b through a layer of intervening material (e.g., cloth, textile, paper, polymer, wood). The retaining bracket 106a, 106b can include a top surface, a bottom surface, and an outer surface 206a, 206b extending between the top surface and the bottom surface, where the outer surface 206a, 206b has multiple curved areas. Furthermore, the retaining bracket 106a, 106b can also include an inner surface 207a, 207b extending between the top surface and the bottom surface of the retaining bracket 106b. In these embodiments, a portion of the inner surface 207a, 207b can define one or more concave walls, where each concave wall defines an elongated receptacle 110a, 110b and extends between the top surface and the bottom surface of the retaining bracket 106a, 106b. The top and bottom surfaces are described in more detail below with reference to FIGS. 7A-8B. Each receptacle 110a, 110b can be shaped as a prismoidal partially open tube. In some embodiments, each magnet 204a, 204b of the first set of magnets can be fully embedded in the backing plate 102a, 102b such that an exposed surface of the magnet is flush with a surface of the backing plate 102a, 102b. In other embodiments, each magnet 204a, 204b of the first set of magnets can either be partially embedded in the backing plate 102a, 102b or attached on a surface of the backing plate 102a, 102b such that each magnet 204a, 204b extends beyond the surface of the backing plate 102a, 102b.

With continued reference to FIGS. 1A-4B, the retaining bracket 106a, 106b can also include multiple tabs 322a, 322b where each tab 322a, 322b respectively extends from an end of a corresponding curved area of the outer surface 206a, 206b. In the several embodiments, each tab 322a, 322b can include magnetic material or have one or more magnets 104a, 104b embedded within it or affixed to it. A magnet 104a, 104b of the second set of magnets can either be partially embedded in a tab 322a, 322b or attached on a surface of the tab 322a, 322b such that the magnet 104a, 104b extends beyond the surface of the tab 322a, 322b. Each tab 322a, 322b can respectively form a part of a corresponding lip 112a, 112b and can respectively be positioned to align with a corresponding magnet 204a, 204b of the first set of magnets on the substantially flat backing plate to fasten the retaining bracket 106a, 106b to the backing plate 102a, 102b by magnetic attraction. In the various embodiments, each receptacle 110a, 110b can be configured to receive a protruding portion of a sport accessory.

In some of these embodiments, the magnetic accessory holder 100a, 100b can also include a second set of magnets, where a magnet 104a, 104b of the second set of magnets is respectively attached to a corresponding tab 322a, 322b of the retaining bracket. The magnet 104a, 104b attached to the tab 322a, 322b can protrude or extend perpendicularly relative to the inner surface of the retaining bracket 106a, 106b (i.e., toward the backing plate 102a, 102b). In some embodiments, each tab 322a, 322b can be a magnet. In some embodiments, one or more of the magnets 104a, 104b of the retaining bracket 106a, 106b can respectively be positioned to align with a corresponding one or more magnets 204a, 204b on the substantially flat backing plate 102a, 102b to fasten the retaining bracket 106a, 106b to the backing plate 102a, 102b by magnetic attraction. In some of these embodiments the sport accessory that each receptacle is configured to receive can be an ear bud or a golf tee.

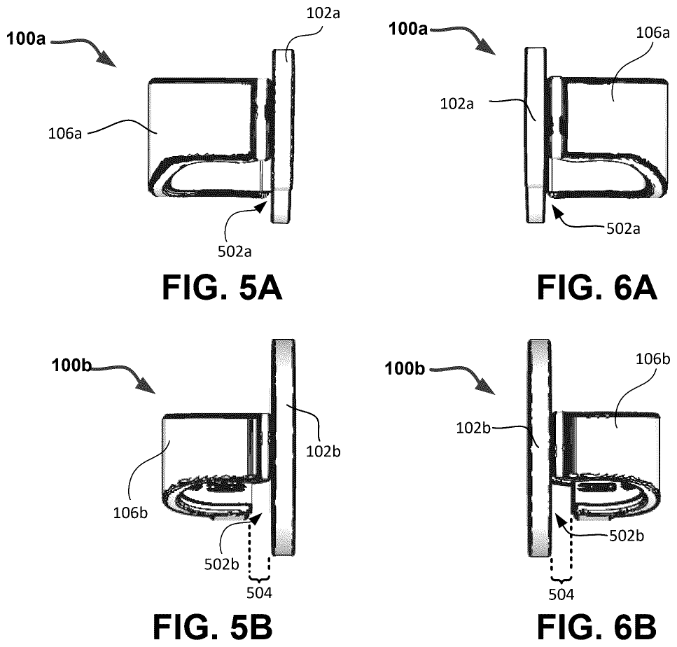

It is contemplated that, in the various embodiments, the backing plate body 202a, 202b, can be formed in a variety of different substantially flat shapes. For example, the backing plate body 202a, 202b, can be formed in a substantially circular or oval shape, as well as in an elliptical shape as depicted in FIGS. 3B and 4B. In some embodiments, the backing plate body 202a, 202b, can be formed in a rectangular or triangular shape or in a shape of any regular or irregular polygon (e.g., semi-circular, polygonal with rounded corners, etc.) The one or more magnets 204a, 204b can be disposed in various location in or on the backing plate body 202a, 202b. Additional details are described further with reference to FIGS. 5A-6B.

FIGS. 5A-5B each respectively depict a right side view of a magnetic accessory holder 100a, 100b in accordance with an embodiments of the present disclosure, while FIGS. 6A-6B each respectively depict a left side view of the magnetic accessory holder 100a, 100b in accordance with some embodiments. In some embodiments, when the retaining bracket 106a is connected to the backing plate 102a, the retaining bracket 106a can be in contact with the backing plate 102a in a region 502a between a flat surface of the retaining bracket 106a and the backing plate 102a. In other embodiments, when the retaining bracket 106b is connected to the backing plate 102b, the retaining bracket 106b can be separated from the backing plate 102b in a region 502b by an offset distance 504 between a flat surface of the retaining bracket 106b and the backing plate 102b.

Turning now to FIGS. 7A-8B, FIGS. 7A-7B are respectively a top and a bottom view of a magnetic accessory holder in accordance with some embodiments while FIGS. 8A-8B are respectively a top and a bottom view of a magnetic accessory holder in accordance with the same or other embodiments.

In some of these embodiments, the magnetic accessory holder 100a, 100b can have a retaining bracket 106a, 106b that has an outer surface 206a, 206b and an inner surface 207a, 207b, each of which has curved and flat portions. Each of the outer surface 206a, 206b and the inner surface 207a, 207b can extend between a top surface 704a, 704b and a bottom surface 804a, 804b of the retaining bracket 106a, 106b. The inner surface 207a, 207b can define one or more elongated channels 108a, 108b where each elongated channel 108a, 108b forms a receptacle 110a, 110b extending from the top surface 704a, 704b to the bottom surface 804a, 804b of the retaining bracket 106a, 106b. Consequently, the depth of the elongated channels 108a, 108b and of the receptacles 110a, 110b can be defined by the length or the distance between the top surface 704a, 704b and the bottom surface 804a, 804b of the retaining bracket 106a, 106b. In some of these embodiments, the retaining bracket 106a, 106b can also include a lip 112a, 112b extending perpendicularly relative to the length between the top surface 704a, 704b and the bottom surface 804a, 804b of the retaining bracket 106a, 106b.

In the several embodiments, the retaining bracket 106a, 106b can include a top surface 704a, 704b and a bottom surface 804a, 804b as well as an inner surface 207a, 207b and an outer surface 206a, 206b. In these embodiments, both the inner surface 207a, 207b and the outer surface 206a, 206b can extend between the top surface 704a, 704b and the bottom surface 804a, 804b. Furthermore, both the inner surface 207a, 207b and the outer surface 206a, 206b can have one or more areas that are curved such that the backing plate 102a, 102b includes one or more curved surfaces 212a, 212b. In these embodiments, a portion of the inner surface 207a, 207b can define one or more concave walls, where each concave wall defines an elongated receptacle 110a, 110b and extends between the top surface 704a, 704b and the bottom surface 804a, 804b of the retaining bracket 106a, 106b.

In these and other embodiments, the prismoidal receptacles 110a, 110b can have various shapes that are substantially prismoidal and that conform to the shape of an article that is intended to be held by the holder. For example, in some embodiments, the receptacle 110a, 110b can be shaped as a rectangular prism or as an octagonal prism. In other embodiments, the receptacle 110a, 110b can be shaped as a cylindrical prism or as an irregular prismoid (e.g., semi-circular prismoid, prismoid with a crescent cross section, etc.)

In some embodiments the width of the receptacle can be defined by a length or diameter 706. Each receptacle 110a, 110b can be separated from another receptacle by a portion 806a, 806b of the retaining bracket 106a, 106b. Furthermore, while in the depicted embodiments, two receptacles 110a, 110b can be seen, embodiments of the present invention are contemplated with any number of receptacles (i.e., one or more receptacles) 110a, 110b. Additionally, in the various embodiments, the distance between the center of one receptacle 110a, 110b from the center of an adjacent receptacle 110a, 110b can be defined by a separation length 810. In these or other embodiments, the inner surface 207a, 207b of the retaining bracket 106a, 106b can be patterned or textured to have protrusions 210 or grooves 712 along a portion of or the entirety of the inner surface 207a, 207b. Such patterning or texturing can serve to improve the grip and friction provided by the accessory holder relative to the accessory that is being held. Furthermore, FIGS. 7B and 8B depict embodiments where the portion 806a, 806b of the retaining bracket 106a, 106b is separated from a surface of the backing plate 102a, 102b by the offset distance 504 when the retaining bracket 106a, 106b is connected to the backing plate 102a, 102b.

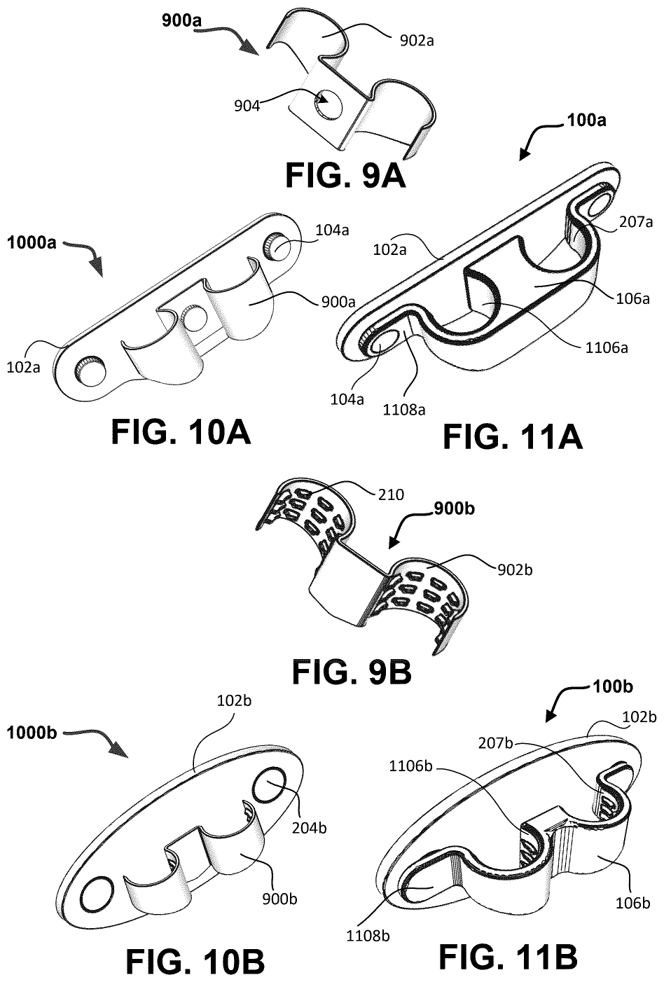

With continued reference to FIGS. 1A-8B and turning to FIGS. 9A-11B additional constituent components of an accessory holder 100a, 100b can be seen. In accordance with some embodiments of the present invention, FIGS. 9A-9B each respectively illustrate a rear perspective view of a conformal layer 900a, 900b of a retaining bracket 106a, 106b, FIGS. 10A-10B each illustrate a front perspective view of a partially assembly 1000a, 1000b of a conformal layer 900a, 900b of a retaining bracket 106a, 106b attached to a backing plate 102a, 102b, while FIGS. 11A-B show a front perspective view of an assembled magnetic accessory holder 100a, 100b.

Accordingly, some embodiments of the present disclosure can include an accessory holder 100a, 100b that has a backing plate 102a, 102b, a first set of magnets 204a, 204b affixed to the backing plate 102a, 102b, and a retaining bracket 106a, 106b with a body having multiple flat surfaces 214a and multiple curved surfaces 212a disposed along the body (i.e., retaining bracket body) 802a, 802b. The retaining bracket 106a, 106b can also include a conformal layer 900a, 900b attached to, attached along, or forming the inner surface 207a, 207b of the retaining bracket. In these and other embodiments the conformal layer 900a, 900b can include a smooth surface 902a, a textured surface 902b, or both a smooth surface 902a and a textured surface 902b.

The curved and flat surfaces can be disposed along the retaining bracket body 802a, 802b and the conformal layer 900a, 900b such that a curved surface 212a, 212b alternates with a flat surface 214a, 214b along the length of the body 802a, 802b of the retaining bracket 106a, 106b. In these and other embodiments each curved surface 212a, 212b can be a part of a curved wall 1106a, 1106b and can define a partially open tubular channel 108a, 108b forming a receptacle 110a, 110b configured to receive a protruding portion of an accessory.

In some embodiments, the accessory holder 100a, 100b can include a second set of magnets affixed to the retaining bracket 106a, 106b, where each magnet 104a, 104b of the second set of magnets is respectively aligned with a corresponding magnet 204a, 204b of the first set of magnets to fasten the retaining bracket 106a, 106b to the backing plate 102a, 102b by magnetic attraction through a layer of intervening material. In some embodiments, at least two flat surfaces 214a, 214b of the retaining bracket body 802a, 802b (i.e., the body of the retaining bracket) each respectively extend along a portion of a lip 112a, 112b extending away from an exterior curved surface 212a, 212b of the body 802a, 802b of the retaining bracket 106a, 106b away from a longitudinal axis of the partially open tubular channel 108a, 108b formed by an interior curved surface 212a, 212b of the retaining bracket 106a, 106b. In these or other embodiments, each curved surface 212a, 212b can be a smooth surface 902a or textured surface 902b that is textured or patterned with grooves 712 or protrusions 210. Furthermore, the conformal layer 900a, 900b can include one or more apertures 904a configured to receive or conform to the shape of a magnet 104a of the second set of magnets.

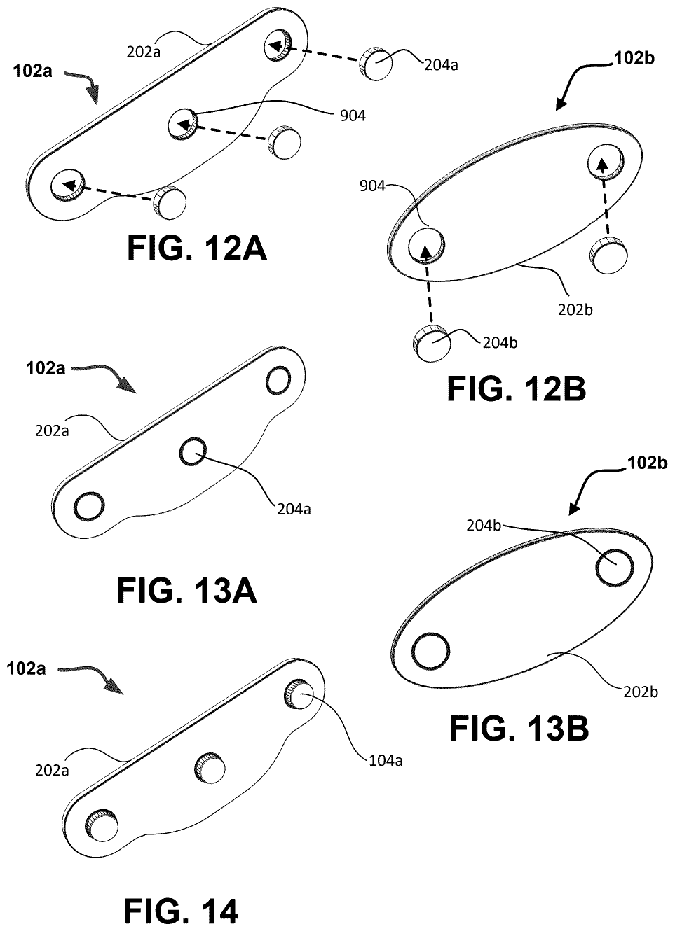

With continued reference to FIGS. 9A-11B, FIGS. 12A-14 views of backing plate bodies 202a, 202b are depicted. FIGS. 12A-12B each respectively show a front perspective view of a backing plate with empty apertures 904 in accordance with some embodiments, while FIGS. 13A, 13B, and 14 each respectively illustrate a front perspective view of a backing plate with embedded or attached magnets in accordance with the several embodiments.

Each backing plate 102a, 102b can have one or more apertures 904 that are configured (i.e., correspondingly shaped) to receive or to fit a corresponding magnet 204a, 204b of the first set of magnets. Each of the various embodiments of the present invention can have a backing plate 102a, 102b with a different number of apertures 904. Consequently, each backing plate 102a, 102b can have a different corresponding number of magnets 204a, 204b that are to fit into the apertures. In some embodiments, the magnets 204a, 204b, once inserted or embedded in the backing plate 102a, 102b, can be dimensioned such that no portion of the magnet 204a, 204b extends beyond either of the exposed surfaces of the backing plate 102a, 102b and such that the exposed surface of each magnet 204a, 204b is flush with the exposed surface of the backing plate 102a, 102b. Various embodiments with any number of magnets 204a, 204b disposed within or along a backing plate 102a, 102b are contemplated by the present disclosure. The distribution of apertures 904 on the body 202a, 202b of the backing plate 102a, 102b and, consequently, the distribution of magnets 204a, 204b within the backing plate 102a, 102b or on the backing plate 102a, 102b can vary among the various embodiments disclosed herein.

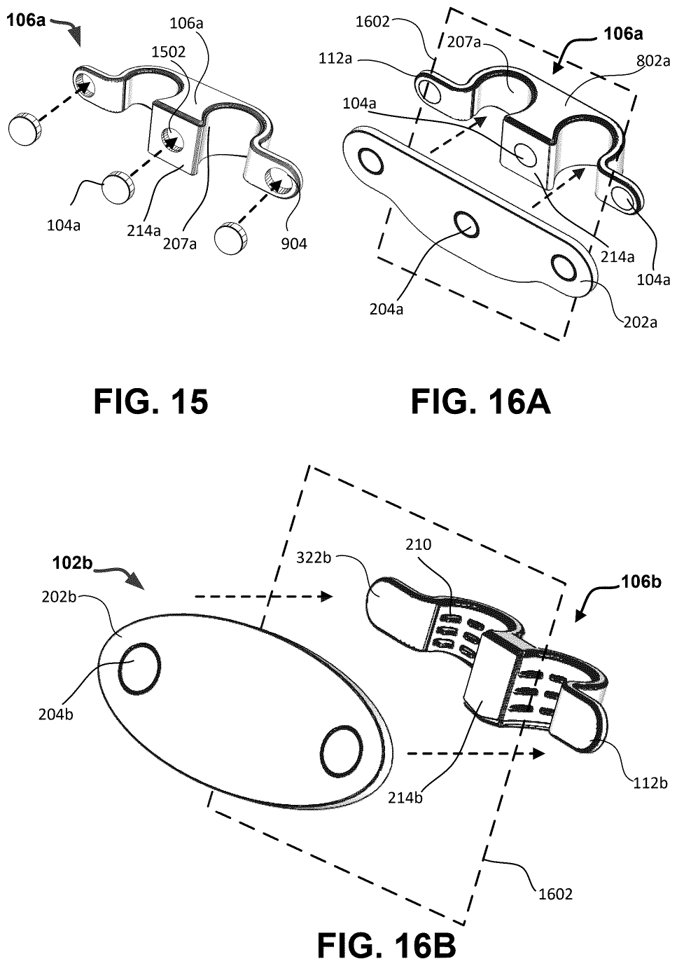

FIG. 15 shows a rear perspective view of a retaining bracket 106a in accordance with some embodiments, while FIGS. 16A-16B each respectively illustrate a rear perspective view of a backing plate body 202a, 202b being attached to a retaining bracket 106a, 106b through an intervening layer 1602 of material (e.g., fabric, clothing) in accordance with some embodiments. In some embodiments, each magnet 104a of the second set of magnets can be inserted or embedded in a corresponding aperture 904 within the retaining bracket 106a. One or more apertures 904 or cavities 1502 (within which a magnet can be embedded) can each be formed within a flat surface 214a, 214b or in a lip 112a, 112b of the retaining bracket 106a, 106b.

In some embodiments, the retaining bracket 106a, 106b of the magnetic accessory holder 100a, 100b can include a second set of magnets, where a magnet 104a, 104b in the second set of magnets can be positioned to align with at least one magnet 204a, 204b of the first set of magnets. In these embodiments, each magnet 204a, 204b can be at least partially embedded in the body 202a, 202b of the backing plate 102a, 102b. In other embodiments, each magnet 204a, 204b can be fully embedded in the body 202a, 202b of the backing plate 102a, 102b such that each magnet's surface is flush with a surface of the backing plate. In yet other embodiments, each magnet 204a, 204b can be affixed onto the surface of the body 202a, 202b of the backing plate 102a, 102b such that each magnet extends away from an exposed surface of the of the body 202a, 202b of the backing plate 102a, 102b and toward the retaining bracket 106a, 106b when the magnetic accessory holder 100a, 100b is in assembled form.

The magnets 204a, 204b of the first set of magnets on the backing plate 102a, 102b can be positioned to align with the magnets 104a, 104b of the second set of magnets on the retaining bracket 106a, 106b. In other embodiments, magnets 204a, 204b of the first set of magnets on the backing plate 102a, 102b can be positioned to align with the tabs 322b and other magnetized areas on the retaining bracket 106a, 106b. The aligned sets of magnets (or magnetized areas) can fasten the retaining bracket 106a, 106b to the backing plate 102a, 102b by magnetic attraction and secure the magnetic accessory holder 100a, 100b on an intervening layer 1602 of material (such as on an item of clothing).

In the various embodiments, a magnet 104a, 104b of the second set of magnets can either be partially embedded in a tab 322a, 322b or attached on a surface of the tab 322a, 322b such that the magnet 104a, 104b extends beyond the surface of the tab 322a, 322b. Each tab 322a, 322b can respectively form a part of a corresponding lip 112a, 112b and can respectively be positioned to align with a corresponding magnet 204a, 204b of the first set of magnets on the substantially flat backing plate to fasten the retaining bracket 106a, 106b to the backing plate 102a, 102b by magnetic attraction and secure the magnetic accessory holder 100a, 100b on an intervening layer 1602 of material (such as on an item of clothing).

FIG. 17 shows a front perspective view of a magnetic accessory holder holding a pair of earbuds 1702 attached to a hat 1700, while FIG. 18 depicts a front view of a magnetic accessory holder 100b holding a pair of golf tees attached to a chest portion of a shirt and a magnetic accessory holder 100a holding a pair of earbuds 1702 attached to a sleeve portion of the shirt 1800 in accordance with some embodiments of the present disclosure. The retaining bracket 106a holds the earbuds 1702 firmly in place against the intervening layer of the hat 1700 by magnetic attraction to the backing plate which is not visible. Accessories, such as golf tees 1802 and earbuds 1702 can easily and conveniently be inserted, retained, and removed from the receptacles of the magnetic accessory holder 100a, 100b.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A magnetic accessory holder comprising:
a backing plate comprising an elongated body wherein a first set of magnets is at least partially embedded in the body of the backing plate;
a retaining bracket comprising:
an outer surface and an inner surface, each of the outer surface and the inner surface extending between a top surface and a bottom surface of the retaining bracket, wherein the inner surface defines a plurality of elongated channels, each elongated channel forming a receptacle extending from the top surface to the bottom surface of the retaining bracket, wherein each receptacle is separated from another receptacle by a portion of the retaining bracket; and
a second set of magnets, wherein each magnet in the second set of magnets is positioned to align with at least one magnet of the first set of magnets at least partially embedded in the body of the backing plate to fasten the retaining bracket to the backing plate by magnetic attraction, and wherein each receptacle is configured to receive a protruding portion of an electronics accessory.

2. The magnetic accessory holder of claim 1, wherein each receptacle is shaped as a partially open cylindrical tube.

3. The magnetic accessory holder of claim 1 wherein each set of magnets comprises three or more magnets.

4. The magnetic accessory holder of claim 3, wherein each magnet of the first set of magnets is partially embedded in the elongated body of the backing plate and partially protruding from the body of the backing plate.

5. The magnetic accessory holder of claim 1, wherein the retaining bracket further comprises a lip extending perpendicularly relative to a length between the top surface and the bottom surface.

6. The magnetic accessory holder of claim 5, wherein at least one magnet of the second set of magnets is embedded in the lip.

7. The magnetic accessory holder of claim 1, wherein the inner surface of the retaining bracket is a textured surface.

8. A magnetic accessory holder comprising:
a substantially flat backing plate comprising an elongated body;
a first set of magnets comprising at least one magnet that is at least partially embedded in the body of the substantially flat backing plate; and
a retaining bracket configured to magnetically attach to the substantially flat backing plate through a layer of intervening material, the retaining bracket comprising:
a top surface;
a bottom surface;
an outer surface extending between the top surface and the bottom surface, wherein the outer surface comprises a plurality of curved areas;
an inner surface extending between the top surface and the bottom surface, wherein a portion of the inner surface defines a plurality of concave walls, each concave wall defining an elongated receptacle and extending between the top surface and the bottom surface; and
a plurality of tabs, each tab respectively extending from an end of a corresponding curved area of the outer surface, wherein each tab comprises magnetic material and each tab is respectively positioned to align with a corresponding magnet of the first set of magnets on the substantially flat backing plate to fasten the retaining bracket to the backing plate by magnetic attraction, and wherein each receptacle is configured to receive a protruding portion of a sport accessory.

9. The magnetic accessory holder of claim 8, wherein each receptacle is shaped as a prismoidal partially open tube.

10. The magnetic accessory holder of claim 8, wherein each magnet of the first set of magnets is fully embedded in the backing plate such that an exposed surface of the magnet is flush with a surface of the backing plate.

11. The magnetic accessory holder of claim 8, further comprising:
a second set of magnets, wherein a magnet of the second set of magnets is respectively attached to a corresponding tab of the retaining bracket and protrudes perpendicularly relative to the inner surface.

12. The magnetic accessory holder of claim 8, wherein each tab is a magnet.

13. The magnetic accessory holder of claim 8, wherein the retaining bracket further comprises a conformal layer attached along the inner surface of the retaining bracket.

14. The magnetic accessory holder of claim 13, wherein the conformal layer comprises at least one textured surface.

15. The magnetic accessory holder of claim 8, wherein the sport accessory is an earbud or a golf tee.

16. An accessory holder comprising:
a backing plate;
a first set of magnets affixed to the backing plate;
a retaining bracket comprising a body having a plurality of flat surfaces and a plurality of curved surfaces disposed along the body such that a curved surface of the plurality of curved surfaces alternates with a flat surface of the plurality of flat surfaces along a length of the body of the retaining bracket, and wherein each curved surface defines a partially open tubular channel forming a receptacle configured to receive a protruding portion of an accessory; and
a second set of magnets affixed to the retaining bracket, wherein each magnet of the second set of magnets is respectively aligned with a corresponding magnet of the first set of magnets to fasten the retaining bracket to the backing plate by magnetic attraction through a layer of intervening material.

17. The accessory holder of claim 16, wherein the accessory is selected from the set comprising a wireless earbud, a golf tee, a screwdriver, pliers, a writing utensil, and a dining utensil.

18. The accessory holder of claim 16, wherein each curved surface is textured with grooves or protrusions.

19. The accessory holder of claim 16, wherein at least two flat surfaces of the plurality of flat surfaces of the body of the retaining bracket each respectively extend along a portion of a lip extending away from an exterior curved surface of the body of the retaining bracket away from a longitudinal axis of the partially open tubular channel formed by an interior curved surface.

20. The accessory holder of claim 16, wherein a longitudinal cross section of each magnet is formed in a shape selected from the set comprising a circle, an oval, a star, a regular polygon, and an irregular polygon.
